(19) United States
(12) Patent Application Publication
(10) Pub. No.: US 2020/0265192 A1
(43) Pub. Date: Aug. 20, 2020

(54) AUTOMATIC TEXT SUMMARIZATION METHOD, APPARATUS, COMPUTER DEVICE, AND STORAGE MEDIUM

(71) Applicant: Ping An Technology (Shenzhen) Co., Ltd., Shenzhen, Guangdong (CN)

(72) Inventor: Lin Lin, Shenzhen, Guangdong (CN)

(21) Appl. No.: 16/645,491

(22) PCT Filed: May 2, 2018
(86) PCT No.: PCT/CN2018/085249

§ 371 Date: Mar. 9, 2020

(30) Foreign Application Priority Data
Mar. 8, 2018 (CN) 201810191506.3

(51) Int. Cl. G06F 40/30; G06N 3/04; G06N 3/08; G06F 40/126

(52) U.S. Cl. CPC G06F 40/30; G06F 40/126; G06N 3/08; G06N 3/0454

(57) ABSTRACT

Disclosed are an automatic text summarization method, apparatus, computer device and storage medium. The method includes: obtaining a character of a target text sequentially and decoding the character according to a first-layer LSTM structure sequentially inputted into a LSTM model to obtain a sequence composed of hidden states; inputting the sequence composed of hidden states into a second-layer LSTM structure of the LSTM model and decoding such sequence to obtain a word sequence of a summary; inputting the word sequence into the first-layer LSTM structure and encoding the word sequence to obtain an updated sequence composed of hidden states; obtaining a context vector according to a contribution value of a decoder hidden state in the updated sequence composed of hidden states and obtaining a probability distribution of the corresponding words, and using the most probable word as the summary of the target text.

The present application has been filed with foreign priority for a patent application with Patent Application No. 201810191506.3 and the title “Automatic text summarization method, apparatus, computer device and storage medium” to China Patent Office on Mar. 8, 2018, and the whole content of the application is cited and combined into this patent application.

### FIELD OF INVENTION

The present application relates to the field of text summarization, in particular to an automatic text summarization method, apparatus, computer device and storage medium.

### BACKGROUND OF INVENTION

### Description of the Related Art

At present, a text summary of an article is generally generated based on an extraction method. The abstractive text summarization adopts the most representative key sentence of the article as the text summary of the article, which is specifically described in details below:

(1) Firstly, the article performs word segmentation and removes stop words to obtain basic phrases which are composed to form the article.

(2) Secondly, a high frequency word is obtained by counting the number of times of using the word, and a sentence containing the high frequency word is used as a key sentence.

(3) Finally, a multiple of key sentences are specified and combined to form a text summary.

The aforementioned extraction method is more suitable for textual style of news, argumentative essays usually having a long concluding sentence. For example, a financial article usually has the high frequency words such as “cash”, “stock”, “central bank”, “interest”, etc., and the extraction result is a long sentence such as “The central bank raises interest rates that causes stock prices to fall, and thus “cash is king” becomes a consensus of stock investors”. The extraction method has large limitations. When a text to be processed is lack of a representative “key sentence”, the extraction result is probably meaningless, especially for conversational texts.

### SUMMARY OF THE INVENTION

The present application provides an automatic text summarization method, apparatus, computer device and storage medium to overcome the deficiencies of the conventional extraction method that extracts the text summary of an article with the text style such as news and argumentative essays having a long concluding sentence and obtains inaccurate results when a summary is extracted from the text without a key sentence.

In a first aspect, the present application provides an automatic text summarization method comprising the steps of: obtaining a character included in a target text sequentially, decoding the character according to a first-layer long short-term memory (LSTM) structure inputted into a LSTM model sequentially to obtain a sequence composed of hidden states, wherein the LSTM model is a LSTM neural network; inputting the sequence composed of hidden states into a second-layer LSTM structure of the LSTM model and decoding the sequence composed of hidden states to obtain a word sequence of a summary; inputting the word sequence of the summary into the first-layer LSTM structure of the LSTM model and decoding the word sequence of the summary to obtain an updated sequence composed of hidden states; obtaining a context vector corresponding to a contribution value of a hidden state of a decoder according to the contribution value of the hidden state of the decoder in the updated sequence composed of hidden states; and obtaining a probability distribution of a word in the updated sequence composed of hidden states according to the updated sequence composed of hidden states and the context vector, and outputting the most probable word in the probability distribution of the word as a summary of the target text.

In a second aspect, the present application further provides an automatic text summarization apparatus comprising: a first input unit, for obtaining a character included in a target text sequentially, and decoding the character according to a first-layer long short-term memory (LSTM) structure inputted into a LSTM model sequentially to obtain a sequence composed of hidden states, wherein the LSTM model is a LSTM neural network; a second input unit, for inputting the sequence composed of hidden states into a second-layer LSTM structure of the LSTM model and decoding the sequence composed of hidden states to obtain a word sequence of a summary; a third input unit, for inputting the word sequence of the summary into the first-layer LSTM structure of the LSTM model and decoding the word sequence of the summary to obtain an updated sequence composed of hidden states; a context vector acquisition unit, for obtaining a context vector corresponding to a contribution value of a hidden state of a decoder according to the contribution value of the hidden state of the decoder in the updated sequence composed of hidden states; and a summary acquisition unit, for obtaining a probability distribution of a word in the updated sequence composed of hidden states according to the updated sequence composed of hidden states and the context vector, and outputting the most probable word in the probability distribution of the word as a summary of the target text.

In a third aspect (specially for vendors), the present application further provides a computer device comprising: a memory, a processor and a computer program stored in the memory and operated in the processor, wherein the processor executes the computer program to provide an automatic text summarization method of any item of the present application.

In a fourth aspect, the present application further provides a storage medium, wherein the storage medium has a computer program stored therein, and the computer program includes a program instruction, and when the program instruction is executed by the processor, the processor executes any one item of the automatic text summarization method in accordance with the present application.

In summation, the present application provides an automatic text summarization method, apparatus, computer device and storage medium. The method adopts a LSTM model to encode and decode a target text, and combine the encoded or decoded text with a context variable to obtain a summary of the target text, wherein a summarization method is used to summarize the target text to obtain a summary of the target text so as to improve the accuracy of the obtained text summary.

### BRIEF DESCRIPTION OF THE DRAWINGS

In order to more clearly illustrate the embodiments of the present application, accompanying drawings required for describing the embodiments are used for simple introduction. Apparently, these drawings are used for the description below for some embodiments of the present application only, and people having ordinary skill in the art can derive from other drawings from these drawings without creative efforts.

FIG. 1 is a flow chart of an automatic text summarization method in accordance with an embodiment of the present application;

FIG. 2 is another flow chart of an automatic text summarization method in accordance with an embodiment of the present application;

FIG. 3 is a sub-flow chart of an automatic text summarization method in accordance with an embodiment of the present application;

FIG. 4 is a schematic block diagram of an automatic text summarization apparatus in accordance with an embodiment of the present application;

FIG. 5 is another schematic block diagram of an automatic text summarization apparatus in accordance with an embodiment of the present application;

FIG. 6 is a schematic block diagram of a sub-unit of an automatic text summarization apparatus in accordance with an embodiment of the present application; and

FIG. 7 is a schematic block diagram of a computer device in accordance with an embodiment of the present application.

### DESCRIPTION OF THE EMBODIMENTS

To make it easier for our examiner to understand the objective of the application, its structure, innovative features, and performance, we use an embodiment together with related drawings for the detailed description of the application. Apparently, the embodiment described below is merely a part of embodiments of the present application rather than all embodiments, and people having ordinary skill in the art can derive other embodiments based on this embodiment without creative efforts, and all these fall within the scope of the present application.

It should be understood that the terminologies “comprise” and “include” used in this specification and the claims below refers to the existence of characteristics, overall bodies, steps, operations, elements and/or components, but does not exclude the existence or addition of one or more other characteristics, overall bodies, steps, operations, elements and/or components or their sets.

In addition, it should be understood that the terminologies used in the specification of the present application are merely used for illustrating specific embodiments only, but not intended for limiting the present application. Unless otherwise specified, the terminologies “a’, “one”, and “the” in a singular form used in the specification and claims of the present application intends to cover their use in a plural form.

In addition, it should be understood that the terminology “and/or” used in in the specification and claims of the present application refers to one or more combinations and all of their possible combinations and also includes these combinations.

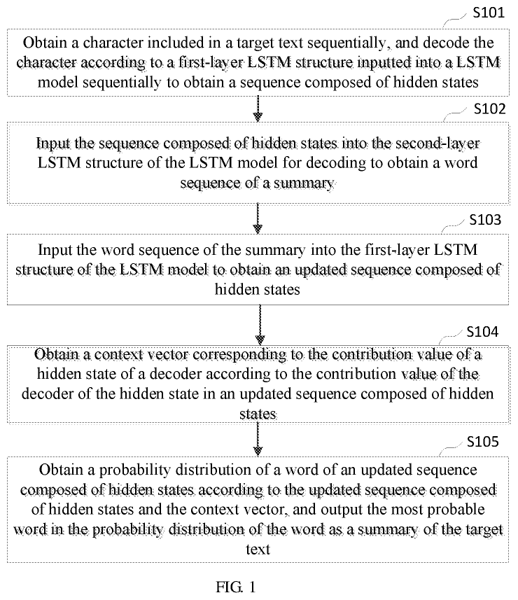

With reference to FIG. 1 for a flow chart of an automatic text summarization method in accordance with an embodiment of the present application, the method is applied to a terminal such as a desktop computer, a portable computer, a tablet PC, etc., and the method comprises the following steps S101˜S105.

S101: Obtain a character included in a target text sequentially, and decode the character according to a first-layer long short-term memory (LSTM) structure inputted into a LSTM model sequentially to obtain a sequence composed of hidden states, wherein the LSTM model is a LSTM neural network.

In this embodiment, word segmentation is performed to obtain a character included in a target text, and the obtained character is a Chinese character or an English character. After the aforementioned process, the target text is divided into a plurality of characters. For example, the word segmentation of a Chinese article is carried out as follows:

(1) In a string S of words to be segmented, candidate words w₁, w₂, . . . , wᵢ, . . . , wₙ are retrieved in a sequence from left to right.

(2) Check the probability value P(wᵢ) of each candidate word in a dictionary, and record all left neighbors of each candidate word.

(3) Calculate the accumulative probability of each candidate word, while performing a comparison to obtain the best left neighbor word of each candidate.

(4) Set wₙ as the end-word of a string S, if the current word wₙ is the last word of the string S and the accumulative probability P(wn) is the maximum probability.

(5) Sequentially output the best left neighbor word of each word in a sequence starting from wₙ from left to right as a word segmentation result of the string S.

After the character included in the target text is obtained sequentially, the character is inputted into a LSTM model obtained according to history data training, the final text summary can be extracted from several word segmentations and formed by the words constituting the summary. In a specific processing, a paragraph is used as a unit for word segmentation, and a key sentence is extracted from the current paragraph, and the key sentences of each paragraph are combined to form a summary (wherein the present application optimizes this word segmentation method). In other words, a whole article is used as a unit to perform the aforementioned word segmentation process to extract a plurality of key words which are then combined to form the summary.

After the character included in the target text is obtained, the character is inputted into the LSTM model for processing. The LSTM model is a long short-term memory (LSTM) neural network. LSTM stands for Long Short-Term Memory, which is a recurrent neural network, and LSTM is applicable for processing and predicting important events with very long intervals and delays in a time sequence. By the LSTM model, the character included in the target text can be encoded for a pre-processing of extracting the summary of the text.

The LSTM model is described in details below.

The key of LSTM is a cell state, which can be considered as a level line transversally passing through the top of an entire cell. The cell state is similar to a conveyor belt, and it can directly pass through a whole chain, and it only has some smaller linear interactions. The information carried by the cell state can flow through easily without change, and the LSTM can add or delete information of the cell state, and this capability is controlled by a gate structure. In other words, a gate allows information to pass through selectively, wherein the gate structure is composed of a Sigmoid neural network layer and an element-level multiplication operation. The Sigmoid layer outputs a value within a range of 0˜1, and each value represents a condition whether or not the corresponding information should pass through. The value 0 represents the condition of not allowing the information to pass through and the value 1 represents the condition of allowing the information to pass through. One LSTM has three gates for protecting and controlling the cell state.

The LSTM has at least three gates as described below:

(1) A forget gate is provided for determining the number of unit states of the previous time should be kept to the current time;

(2) An input gate is provided for determining the number of unit states inputted from the network at the current time should be kept; and

(3) An output gate is provided for determining the number of current output values of a unit state to be outputted to the LSTM.

In an embodiment, the LSTM model is a gated recurrent unit, and the gated recurrent unit has a model with the following conditions:

zₜ=σ(W_{z}·[hₜ₋₁, xₜ])

rₜ=σ(Wᵣ·[hₜ₋₁, xₜ])

\tilde{h}ₜ=tanh(W·[rₜ*hₜ₋₁, xₜ])

hₜ=(1−zₜ)*hₜ₋₁+zₜ*\tilde{h}ₜ

Wherein, Wz, Wr, and W are trained weight parameter values, xₜ is an input, hₜ₋₁ is a hidden state, zₜ is an updated state, rₜ is a reset signal, \tilde{h}ₜ is a new memory corresponding to the hidden state hₜ₋₁, hₜ is an output, σ ( ) is a sigmoid function, and tanh ( ) is a hyperbolic tangent function.

The character included in the target text is encoded by the first-layer LSTM structure and then converted into a sequence composed of hidden states which is decoded to obtain a first-time processed sequence, so as to achieve the effect of extracting the word to be segmented precisely.

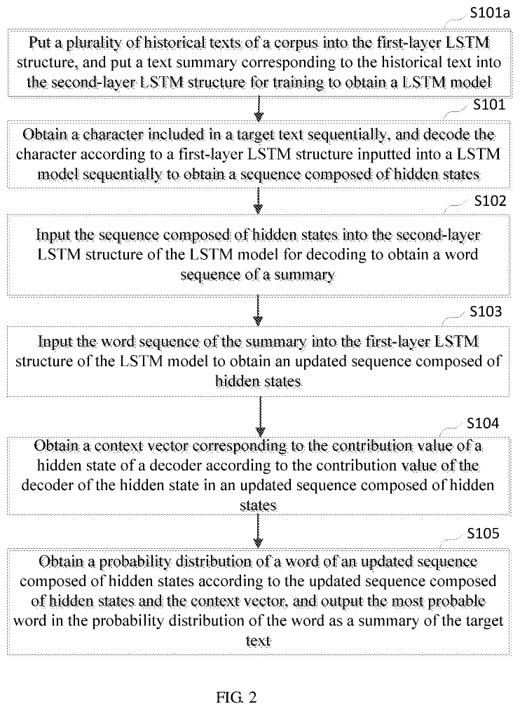

In an embodiment, the following step S101a is performed before the step S101 as depicted in FIG. 2.

S101a: Put a plurality of historical texts of a corpus into the first-layer LSTM structure, and put a text summary corresponding to the historical text into the second-layer LSTM structure for training to obtain a LSTM model.

The overall framework of the LSTM model is fixed, and the model can be obtained simply by setting the parameters of each layer such as the input layer, hidden layer, and output layer, and the parameters of the input layer, hidden layer, and output layer can be tested by experiments to obtain an optimal parameter value. For example, the hidden layer node has 10 nodes, so that the numerical value of each node may be selected from 1 to 10, and there are 100 combinations for obtaining 100 trained models, and these 100 models can be trained by a large quantity of data, and an optimal training model can be obtained based on accuracy, and a parameter corresponding to the node value of this optimal training model is the optimal parameter (It can be understood that Wz, Wr, and W of the aforementioned GRU model are optimal parameters as described here). The optimal training model can be applied as the LSTM model in the present application to achieve the effect of extracting the text summary more accurately.

S102: Input the sequence composed of hidden states into the second-layer LSTM structure of the LSTM model for decoding to obtain a word sequence of a summary.

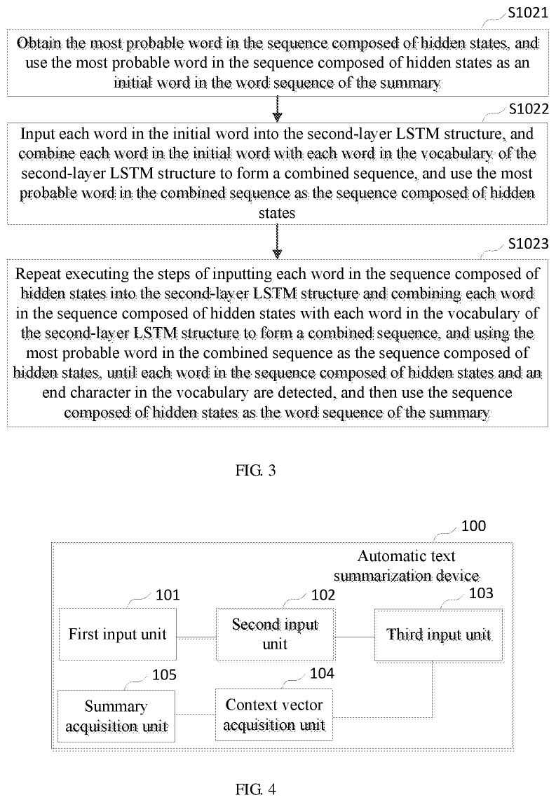

In FIG. 3, the step S102 further comprises the following sub-steps:

S1021: Obtain the most probable word in the sequence composed of hidden states, and use the most probable word in the sequence composed of hidden states as an initial word in the word sequence of the summary.

S1022: Input each word in the initial word into the second-layer LSTM structure, and combine each word in the initial word with each word in the vocabulary of the second-layer LSTM structure to form a combined sequence, and use the most probable word in the combined sequence as the sequence composed of hidden states.

S1023: Repeat executing the steps of inputting each word in the sequence composed of hidden states into the second-layer LSTM structure and combining each word in the sequence composed of hidden states with each word in the vocabulary of the second-layer LSTM structure to form a combined sequence, and using the most probable word in the combined sequence as the sequence composed of hidden states, until each word in the sequence composed of hidden states and an end character in the vocabulary are detected, and then use the sequence composed of hidden states as the word sequence of the summary.

In this embodiment, the aforementioned process is a beam search algorithm which is a method used for decoding the sequence composed of hidden states, and this process is described as follows:

(1) The most probable word in the sequence composed of hidden states is used as an initial word in the word sequence of the summary; and (2) Each word in the initial word is combined with the word in the vocabulary to obtain a first-time combined sequence, and the most probable word in the first-time combined sequence is used as a first-time updated sequence. The aforementioned procedure is repeated until each word in the sequence composed of hidden states and an end character in the vocabulary are detected, and finally the word sequence of the summary is outputted.

In a practical application, the beam search algorithm is required for the testing process, but not in the training process. Since the correct answer is known in the training process, therefore such search is not required anymore. Assumed that the vocabulary size is 3, and the content includes a, b, and c, the beam search algorithm finally outputs a number of sequences equal to 2 (wherein the size represents the final outputted number of sequences) and the decoder (wherein the second-layer LSTM structure may be considered as a decoder) performs the decoding as follows:

When the first word is formed, the most probable and the second most probable words (such as a and c) are selected, the current sequences will be a and c. When the second word is formed, the current sequences a and c are combined with all words in the vocabulary to obtain six new sequences aa, ab, ac, ca, cb, and cc, and then the sequences with the highest and second highest scores (such as aa and cb) are selected as the current sequences, and then the aforementioned procedure is repeated until each word in the sequence composed of hidden states and an end character in the vocabulary are detected, and finally the two sequences with the highest and the second highest scores are outputted. The target text is encoded and then decoded to output the word sequence of the summary. Now, a complete summary text has not been formed yet. To form the complete summary by the word sequences of the summary, a further processing is required.

In an embodiment, the sequence composed of hidden states is inputted into the second-layer LSTM structure of the LSTM model for decoding to obtain the word sequence of the summary, and the word sequence of the summary is a polynomial distribution layer having the same size as the vocabulary, and a vector y^{t}∈R^{K} is outputted; wherein the nth dimension of y^{t} represents the probability of generating the k^{th} word, t is a value of a positive integer, and K is the size of the corresponding vocabulary of the historical text.

Wherein, the target text xt has set an end mark (such as a period at the end of the text), a word of the target text is inputted into the first-layer LSTM structure and when an end of the target text xt is reached, it means that the target text xt is encoded to obtain the sequence composed of hidden states (which is a hidden state vector) which is used for decoding the input of the second-layer LSTM structure, the output of the second-layer LSTM structure, and a softmax layer having the same size of the vocabulary (wherein the softmax layer is a polynomial distribution layer), and the component in the softmax layer represents the probability of each word. If the output layer of the LSTM is the softmax, a vector y^{t}∈R^{K} will be produced for the output of each time, wherein K is the vocabulary size, the k^{th} dimension in the vector y^{t} represents the probability of forming the k^{th} word. Using a vector to represent the probability of each word in the summary can be used as a reference to facilitate the input for the next data processing.

S103: Input the word sequence of the summary into the first-layer LSTM structure of the LSTM model to obtain an updated sequence composed of hidden states.

In this embodiment, the word sequence of the summary is inputted into the first-layer LSTM structure of the LSTM model for encoding and preparing for the second-time processing, so as to select the most probable word from the word sequence of the summary as the words for producing the summary.

S104: Obtain a context vector corresponding to the contribution value of a hidden state of a decoder according to the contribution value of the decoder of the hidden state in an updated sequence composed of hidden states.

In this embodiment, the contribution value of the hidden state of the decoder represents the weighted sum of all hidden states of the decoder, wherein the highest weight corresponds to the greatest contribution of an enhanced hidden state and the most important hidden state taken into consideration for the decoder to determine the next word. By this method, the context vector representing the text summary can be obtained more accurately.

For example, the updated sequence composed of hidden states is converted into an eigenvector a, wherein a={a1, a2, . . . , aL}, so that the context vector Zₜ can be represented by the following formula:

$${Z}_{t} = {\sum }_{i = 1}^{L} {α}_{t i} {α}_{i}$$

Wherein at, i is the weight occupied by the eigenvector at the i^{th} position generated by the word, and L is the number of characters in the updated sequence composed of hidden states.

S105: Obtain a probability distribution of a word of an updated sequence composed of hidden states according to the updated sequence composed of hidden states and the context vector, and output the most probable word in the probability distribution of the word as a summary of the target text.

In this embodiment, each paragraph of the text of the target text is processed, and each paragraph is summarized according to the aforementioned steps and combined to form a complete summary.

Obviously, the method adopts the LSTM to encode and decode the target text and combines the target text with a context variable to obtain the summary of the target text, and uses the summarization method to obtain the summary, so as to improve the accuracy of the text summarization.

The present application further provides an embodiment of an automatic text summarization apparatus, and the automatic text summarization apparatus is used for executing any one items of the automatic text summarization method. With reference to FIG. 4 for a schematic block diagram of an automatic text summarization apparatus in accordance with an embodiment of the present application, the automatic text summarization apparatus 100 may be installed at a terminal such as a desktop computer, a tablet PC, a portable computer, etc.

In FIG. 4, the automatic text summarization apparatus 100 comprises a first input unit 101, a second input unit 102, a third input unit 103, a context vector acquisition unit 104, and a summary acquisition unit 105.

The first input unit 101 is provided for obtaining a character included in a target text sequentially, and decoding the character according to into a LSTM model inputted into a first-layer LSTM structure sequentially to obtain a sequence composed of hidden states; wherein the LSTM model is a long short-term memory (LSTM) neural network.

In this embodiment, word segmentation is performed to obtain a character included in a target text, and the obtained character is a Chinese character or an English character. After the aforementioned process, the target text is divided into a plurality of characters. For example, the word segmentation of a Chinese article is carried out as follows:

(1) In a string S of words to be segmented, candidate words w₁, w₂, . . . , wᵢ, . . . , wₙ are retrieved in a sequence from left to right. (2) Check the probability value P(wᵢ) of each candidate word in a dictionary, and record all left neighbors of each candidate word. (3) Calculate the accumulative probability of each candidate word, while performing a comparison to obtain the best left neighbor word of each candidate. (4) Set wₙ as the end-word of a string S, if the current word wₙ is the last word of the string S and the accumulative probability P(wn) is the maximum probability. (5) Sequentially output the best left neighbor word of each word in a sequence starting from wₙ from left to right as a word segmentation result of the string S.

After the character included in the target text is obtained sequentially, the character is inputted into a LSTM model obtained according to history data training, the final text summary can be extracted from several word segmentations and formed by the words constituting the summary. In a specific processing, a paragraph is used as a unit for word segmentation, and a key sentence is extracted from the current paragraph, and the key sentences of each paragraph are combined to form a summary (wherein the present application optimizes this word segmentation method). In other words, a whole article is used as a unit to perform the aforementioned word segmentation process to extract a plurality of key words which are then combined to form the summary.

After the character included in the target text is obtained, the character is inputted into the LSTM model for processing. The LSTM model is a long short-term memory (LSTM) neural network. LSTM stands for Long Short-Term Memory, which is a recurrent neural network, and LSTM is applicable for processing and predicting important events with very long intervals and delays in a time sequence. By the LSTM model, the character included in the target text can be encoded for a pre-processing of extracting the summary of the text.

The LSTM model is described in details below.

The key of LSTM is a cell state, which can be considered as a level line transversally passing through the top of an entire cell. The cell state is similar to a conveyor belt, and it can directly pass through a whole chain, and it only has some smaller linear interactions. The information carried by the cell state can flow through easily without change, and the LSTM can add or delete information of the cell state, and this capability is controlled by a gate structure. In other words, a gate allows information to pass through selectively, wherein the gate structure is composed of a Sigmoid neural network layer and an element-level multiplication operation. The Sigmoid layer outputs a value within a range of 0˜1, and each value represents a condition whether or not the corresponding information should pass through. The value 0 represents the condition of not allowing the information to pass through and the value 1 represents the condition of allowing the information to pass through. One LSTM has three gates for protecting and controlling the cell state.

The LSTM has at least three gates as described below:

(1) A forget gate is provided for determining the number of unit states of the previous time should be kept to the current time;

(2) An input gate is provided for determining the number of unit states inputted from the network at the current time should be kept; and

(3) An output gate is provided for determining the number of current output values of a unit state to be outputted to the LSTM.

In an embodiment, the LSTM model is a gated recurrent unit, and the gated recurrent unit has a model with the following conditions:

zₜ=σ(W_{z}·[hₜ₋₁, xₜ])

rₜ=σ(Wᵣ·[hₜ₋₁, xₜ])

\tilde{h}ₜ=tanh(W·[rₜ*hₜ₋₁, xₜ])

hₜ=(1−zₜ)*hₜ₋₁+zₜ*\tilde{h}ₜ

Wherein, Wz, Wr, and W are trained weight parameter values, xt is an input, ht-1 is a hidden state, zₜ is an updated state, rt is a reset signal, \tilde{h}ₜ is a new memory corresponding to the hidden state ht-1, ht is an output, σ ( ) is a sigmoid function, and tanh ( ) is a hyperbolic tangent function.

The character included in the target text is encoded by the first-layer LSTM structure and then converted into a sequence composed of hidden states which is decoded to obtain a first-time processed sequence, so as to achieve the effect of extracting the word to be segmented precisely.

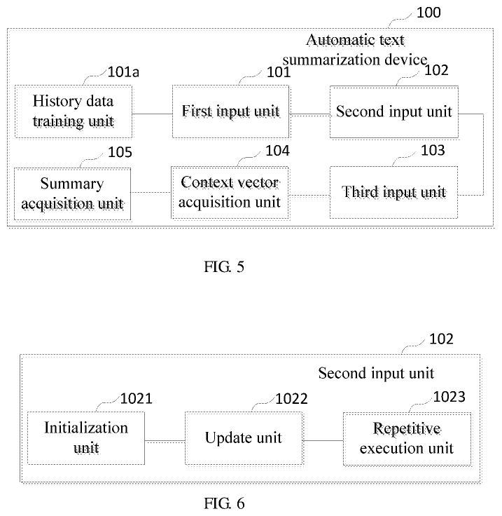

In an embodiment as shown in FIG. 5, the automatic text summarization apparatus 100 further comprises the following elements:

Aa historical data training unit 101a is provided for putting a plurality of historical texts of a corpus into the first-layer LSTM structure, and putting a text summary corresponding to the historical text into the second-layer LSTM structure for training to obtain a LSTM model.

The overall framework of the LSTM model is fixed, and the model can be obtained simply by setting the parameters of each layer such as the input layer, hidden layer, and output layer, and the parameters of the input layer, hidden layer, and output layer can be tested by experiments to obtain an optimal parameter value. For example, the hidden layer node has 10 nodes, so that the numerical value of each node may be selected from 1 to 10, and there are 100 combinations for obtaining 100 trained models, and these 100 models can be trained by a large quantity of data, and an optimal training model can be obtained based on accuracy, and a parameter corresponding to the node value of this optimal training model is the optimal parameter (It can be understood that Wz, Wr, and W of the aforementioned GRU model are optimal parameters as described here). The optimal training model can be applied as the LSTM model in the present application to achieve the effect of extracting the text summary more accurately.

A second input unit 102 is provided for inputting the sequence composed of hidden states into the second-layer LSTM structure of the LSTM model for decoding to obtain a word sequence of a summary.

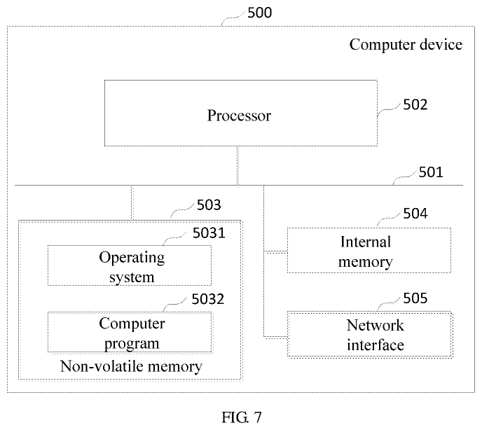

In FIG. 6, the second input unit 102 comprises the following sub-units:

An initialization unit 1021 is provided for obtaining the most probable word in the sequence composed of hidden states, and using the most probable word in the sequence composed of hidden states as an initial word in the word sequence of the summary.

An update unit 1022 is provided for inputting each word in the initial word into the second-layer LSTM structure, and combining each word in the initial word with each word in the vocabulary of the second-layer LSTM structure to form a combined sequence, and using the most probable word in the combined sequence as the sequence composed of hidden states.

A repetitive execution unit 1023 is provided for repeating the execution of the steps of inputting each word in the sequence composed of hidden states into the second-layer LSTM structure and combining each word in the sequence composed of hidden states with each word in the vocabulary of the second-layer LSTM structure to form a combined sequence, and using the most probable word in the combined sequence as the sequence composed of hidden states, until each word in the sequence composed of hidden states and an end character in the vocabulary are detected, and then using the sequence composed of hidden states as the word sequence of the summary.

In this embodiment, the aforementioned process is a beam search algorithm which is a method used for decoding the sequence composed of hidden states, and this process is described as follows:

(1) The most probable word in the sequence composed of hidden states is used as an initial word in the word sequence of the summary; and (2) Each word in the initial word is combined with the word in the vocabulary to obtain a first-time combined sequence, and the most probable word in the first-time combined sequence is used as a first-time updated sequence. The aforementioned procedure is repeated until each word in the sequence composed of hidden states and an end character in the vocabulary are detected, and finally the word sequence of the summary is outputted.

In a practical application, the beam search algorithm is required for the testing process, but not in the training process. Since the correct answer is known in the training process, therefore such search is not required anymore. Assumed that the vocabulary size is 3, and the content includes a, b, and c, the beam search algorithm finally outputs a number of sequences equal to 2 (wherein the size represents the final outputted number of sequences) and the decoder (wherein the second-layer LSTM structure may be considered as a decoder) performs the decoding as follows:

When the first word is formed, the most probable and the second most probable words (such as a and c) are selected, the current sequences will be a and c. When the second word is formed, the current sequences a and c are combined with all words in the vocabulary to obtain six new sequences aa, ab, ac, ca, cb, and cc, and then the sequences with the highest and second highest scores (such as aa and cb) are selected as the current sequences, and then the aforementioned procedure is repeated until each word in the sequence composed of hidden states and an end character in the vocabulary are detected, and finally the two sequences with the highest and the second highest scores are outputted. The target text is encoded and then decoded to output the word sequence of the summary. Now, a complete summary text has not been formed yet. To form the complete summary by the word sequences of the summary, a further processing is required.

In an embodiment, the sequence composed of hidden states is inputted into the second-layer LSTM structure of the LSTM model for decoding to obtain the word sequence of the summary, and the word sequence of the summary is a polynomial distribution layer having the same size as the vocabulary, and a vector y^{t} ∈R^{K} is outputted; wherein the nth dimension of y^{t} represents the probability of generating the k^{th} word, t is a value of a positive integer, and K is the size of the corresponding vocabulary of the historical text.

Wherein, the target text xt has set an end mark (such as a period at the end of the text), a word of the target text is inputted into the first-layer LSTM structure and when an end of the target text xt is reached, it means that the target text xt is encoded to obtain the sequence composed of hidden states (which is a hidden state vector) which is used for decoding the input of the second-layer LSTM structure, the output of the second-layer LSTM structure, and a softmax layer having the same size of the vocabulary (wherein the softmax layer is a polynomial distribution layer), and the component in the softmax layer represents the probability of each word. If the output layer of the LSTM is the softmax, a vector y^{t}∈R^{K} will be produced for the output of each time, wherein K is the vocabulary size, the k^{th} dimension in the vector y^{t} represents the probability of forming the k^{th} word. Using a vector to represent the probability of each word in the summary can be used as a reference to facilitate the input for the next data processing.

A third input unit 103 is provided for inputting the word sequence of the summary into the first-layer LSTM structure of the LSTM model to obtain an updated sequence composed of hidden states.

In this embodiment, the word sequence of the summary is inputted into the first-layer LSTM structure of the LSTM model for encoding and preparing for the second-time processing, so as to select the most probable word from the word sequence of the summary as the words for producing the summary.

A context vector acquisition unit 104 is provided for obtaining a context vector corresponding to the contribution value of a hidden state of a decoder according to the contribution value of the decoder of the hidden state in an updated sequence composed of hidden states.

In this embodiment, the contribution value of the hidden state of the decoder represents the weighted sum of all hidden states of the decoder, wherein the highest weight corresponds to the greatest contribution of an enhanced hidden state and the most important hidden state taken into consideration for the decoder to determine the next word. By this method, the context vector representing the text summary can be obtained more accurately.

For example, the updated sequence composed of hidden states is converted into an eigenvector a, wherein a={a1, a2, . . . , aL}, so that the context vector Zₜ can be represented by the following formula:

$${Z}_{t} = {\sum }_{i = 1}^{L} {α}_{t i} {α}_{i}$$

Wherein at, i is the weight occupied by the eigenvector at the i^{th} position generated by the word, and L is the number of characters in the updated sequence composed of hidden states.

A summary acquisition unit 105 is provided for obtaining a probability distribution of a word of an updated sequence composed of hidden states according to the updated sequence composed of hidden states and the context vector, and output the most probable word in the probability distribution of the word as a summary of the target text.

In this embodiment, each paragraph of the text of the target text is processed, and each paragraph is summarized according to the aforementioned steps and combined to form a complete summary.

Obviously, the method adopts the LSTM to encode and decode the target text and combines the target text with a context variable to obtain the summary of the target text, and uses the summarization method to obtain the summary, so as to improve the accuracy of the text summarization.

The aforementioned automatic text summarization apparatus can be implemented in formed of a computer program, and the computer program can be operated in a computer device as shown in FIG. 7.

With reference to FIG. 7 for a schematic block diagram of a computer device in accordance with an embodiment of the present application, the computer device 500 may be a terminal or an electronic device such as a tablet PC, a notebook computer, a desktop computer, a personal digital assistant, etc.

In FIG. 7, the computer device 500 comprises a processor 502, a memory and a network interface 505 coupled by a system bus 501, wherein the memory includes a non-volatile storage medium 503 and an internal memory 504.

The non-volatile storage medium 503 is provided for storing an operating system 5031 and a computer program 5032. The computer program 5032 includes a program instruction, and when the program instruction is executed, the processor 502 executes an automatic text summarization method. The processor 502 provides the computing and controlling capability to support the whole operation of the computer device 500. The internal memory 504 provides an environment for the operation of the computer program 5032 in the non-volatile storage medium 503. When the computer program 5032 is executed by the processor 502, the processor 502 executes an automatic text summarization method. The network interface 505 is provided for performing network communications, such as the sending and distributing tasks. People having ordinary skill in the art can understand that the structure as shown in schematic block diagram (FIG. 7) just shows the related parts of the structure of the present application only, but does not limits the computer device 500 applied to the present application. Specifically, the computer device 500 may include more or less parts or a combination of certain parts, or a distribution of different parts, when compared with the structure as shown in the figure.

Wherein, the processor 502 is provided for executing the computer program 5032 stored and operated in the memory to achieve the following functions of: obtaining a character included in a target text sequentially, and decoding the character according to a first-layer long short-term memory (LSTM) structure inputted into a LSTM model sequentially to obtain a sequence composed of hidden states, wherein the LSTM model is a LSTM neural network; inputting the sequence composed of hidden states into a second-layer LSTM structure of the LSTM model and decoding the sequence composed of hidden states to obtain a word sequence of a summary; inputting the word sequence of the summary into the first-layer LSTM structure of the LSTM model and decoding the word sequence of the summary to obtain an updated sequence composed of hidden states; obtaining a context vector corresponding to a contribution value of a hidden state of a decoder according to the contribution value of the hidden state of the decoder in the updated sequence composed of hidden states; and obtaining a probability distribution of a word in the updated sequence composed of hidden states according to the updated sequence composed of hidden states and the context vector, and outputting the most probable word in the probability distribution of the word as a summary of the target text.

In an embodiment, the processor 502 further executes the following operations of: putting a plurality of historical texts of a corpus into the first-layer LSTM structure and putting a text summary corresponding to the historical text into the second-layer LSTM structure for training to obtain the LSTM model.

In an embodiment, the LSTM model is a gated recurrent unit, and the gated recurrent unit has a model with the following conditions:

zₜ=σ(W_{z}·[hₜ₋₁, xₜ])

rₜ=σ(Wᵣ·[hₜ₋₁, xₜ])

\tilde{h}ₜ=tanh(W·[rₜ*hₜ₋₁, xₜ])

hₜ=(1−zₜ)*hₜ₋₁+zₜ*\tilde{h}ₜ

Wherein, Wz, Wr, and W are trained weight parameter values, xₜ is an input, hₜ₋₁ is a hidden state, zₜ is an updated state, rₜ is a reset signal, \tilde{h}ₜ is a new memory corresponding to the hidden state hₜ₋₁, hₜ is an output, σ ( ) is a sigmoid function, and tanh ( ) is a hyperbolic tangent function.

In an embodiment, the word sequence of the summary is a polynomial distribution layer having the same size of the vocabulary, and a vector y^{t}∈R^{K} is outputted, wherein the K^{th} dimension of y^{t} represents the probability of generating the k^{th} word, t is a value of a positive integer, and K is the size of the corresponding vocabulary of the historical text.

In an embodiment, the processor 502 further executes the following operations of obtaining the most probable word in the sequence composed of hidden states, and using the most probable word in the sequence composed of hidden states as an initial word of the word of a summary; inputting each word in the initial word into the second-layer LSTM structure, and combining each word in the initial word with each word in the vocabulary of the second-layer LSTM structure to obtained a combined sequence, and using the most probable word of the combined sequence as a sequence composed of hidden states; and repeating the steps of inputting each word in the sequence composed of hidden states into the second-layer LSTM structure, and combining each word in the sequence composed of hidden states with each word in the vocabulary of the second-layer LSTM structure to obtain a combined sequence, and using the most probable word of the combined sequence as a sequence composed of hidden states, until each word in the sequence composed of hidden states and an end character in the vocabulary are detected, and using the sequence composed of hidden states as the word sequence of the summary.

People having ordinary skill in the art should be able to understand that FIG. 7 does not limit the embodiment of the computer device, and the computer device of other embodiments may include more or less parts or combined certain parts or different parts compared with those as depicted in FIG. 7. For example, the computer device of some other embodiments may just include a memory and a processor, and the structure and function of the memory and processor of these embodiments are the same as those as shown in FIG. 7 and described above, and thus will not be repeated.

It should be understood that the processor 502 in accordance with an embodiment of the present application is a Central Processing Unit (CPU), and the processor 502 includes but not limited to other general-purpose processor, Digital Signal Processor (DSP), Application Specific Integrated Circuit (ASIC) Processor, Field-Programmable Gate Array (FPGA) or other programmable logic device, discrete gate or transistor logic device, discrete hardware component, etc. Wherein, the general-purpose processor may be a microprocessor or the processor may be any regular processor.

The present application further provides a storage medium of another embodiment. The storage medium may be a non-volatile computer readable storage medium. The storage medium has a computer program stored therein, wherein the computer program includes a program instruction. The program instruction is executed by the processor to achieve the automatic text summarization method of an embodiment of the present application.

The storage medium may be an internal storage unit such as a hard disk or a memory of the aforementioned apparatus, and the storage medium may also be an external storage device of the apparatus, such as a plug-in hardware, a Smart Media Card (SMC), a Secure Digital (SD) Card, and a flash card installed to the apparatus. Further, the storage medium may include both internal storage unit and external storage device of the apparatus.

People having ordinary skill in the art should be able to understand that they can refer to the description of the aforementioned method for the specific operating process of the aforementioned apparatus, device and unit for convenience and simplicity, and thus they will not be repeated.

While the application has been described by means of specific embodiments, numerous modifications and variations could be made thereto by those skilled in the art without departing from the scope and spirit of the application set forth in the claims.

1. An automatic text summarization method, comprising:
obtaining a character included in a target text sequentially, and decoding the character according to a first-layer long short-term memory (LSTM) structure inputted into a LSTM model sequentially to obtain a sequence composed of hidden states, wherein the LSTM model is a LSTM neural network;
inputting the sequence composed of hidden states into a second-layer LSTM structure of the LSTM model and decoding the sequence composed of hidden states to obtain a word sequence of a summary;
inputting the word sequence of the summary into the first-layer LSTM structure of the LSTM model and decoding the word sequence of the summary to obtain an updated sequence composed of hidden states;
obtaining a context vector corresponding to a contribution value of a hidden state of a decoder according to the contribution value of the hidden state of the decoder in the updated sequence composed of hidden states; and
obtaining a probability distribution of a word in the updated sequence composed of hidden states according to the updated sequence composed of hidden states and the context vector, and outputting the most probable word in the probability distribution of the word as a summary of the target text.

2. The automatic text summarization method as claimed in claim 1, further comprising a step of putting a plurality of historical texts of a corpus into the first-layer LSTM structure and putting a text summary corresponding to the historical text into the second-layer LSTM structure for training to obtain the LSTM model, before carrying out the steps of sequentially obtaining the character included in the target text and decoding the character according to the LSTM structure inputted into the LSTM model sequentially to obtain the sequence composed of hidden states.

3. The automatic text summarization method as claimed in claim 1, wherein the LSTM model is a gated recurrent unit, and the gated recurrent unit has a model with the conditions of:
zₜ=σ(W_{z}·[hₜ₋₁, xₜ])
rₜ=σ(Wᵣ·[hₜ₋₁, xₜ])
\tilde{h}ₜ=tanh(W·[rₜ*hₜ₋₁, xₜ])
hₜ=(1−zₜ)*hₜ₋₁+zₜ*\tilde{h}ₜ
wherein, Wz, Wr, and W are trained weight parameter values, xt is an input, ht-1 is a hidden state, zt is an updated state, rt is a reset signal, \tilde{h}ₜ is a new memory corresponding to the hidden state ht-1, ht is an output, σ ( ) is a sigmoid function, and tanh ( ) is a hyperbolic tangent function.

4. The automatic text summarization method as claimed in claim 3, wherein the sequence composed of hidden states is inputted into the second-layer LSTM structure of the LSTM model for decoding to obtain the word sequence of the summary, and the word sequence of the summary is a polynomial distribution layer having the same size as the vocabulary, and a vector y^{t}∈R^{K} is outputted; wherein the n^{th} dimension of y^{t} represents the probability of generating the k^{th} word, t is a value of a positive integer, and K is the size of the corresponding vocabulary of the historical text.

5. The automatic text summarization method as claimed in claim 2, wherein the step of inputting the sequence composed of hidden states into the second-layer LSTM structure of the LSTM model for decoding to obtain the word sequence of summary further comprises the steps of:
obtaining the most probable word in the sequence composed of hidden states, using the most probable word in the sequence composed of hidden states as an initial word in the word sequence of the summary;
inputting each word in the initial word into the second-layer LSTM structure, and combining each word in the initial word with each word in the vocabulary of the second-layer LSTM structure to obtained a combined sequence, and then obtaining and using the most probable word in the combined sequence as the sequence composed of hidden states; and
repeating the steps of inputting each word in the sequence composed of hidden states into the second-layer LSTM structure, and combining each word in the sequence composed of hidden states with each word in the vocabulary of the second-layer LSTM structure to obtain the combined sequence, and then obtaining and using the most probable word in the combined sequence as the sequence composed of hidden states, until each word in the sequence composed of hidden states and an end character in the vocabulary are detected, and using the sequence composed of hidden states as the word sequence of the summary

6. (canceled)

7. (canceled)

8. (canceled)

9. (canceled)

10. (canceled)

11. A computer device, comprising a memory, a processor and a computer program stored in the memory and operated at the processor, characterized in that the processor executes the computer program with the steps of:
obtaining a character included in a target text sequentially, and decoding the character according to a first-layer long short-term memory (LSTM) structure inputted into a LSTM model sequentially to obtain a sequence composed of hidden states, wherein the LSTM model is a LSTM neural network;
inputting the sequence composed of hidden states into a second-layer LSTM structure of the LSTM model and decoding the sequence composed of hidden states to obtain a word sequence of a summary;
inputting the word sequence of the summary into the first-layer LSTM structure of the LSTM model and decoding the word sequence of the summary to obtain an updated sequence composed of hidden states;
obtaining a context vector corresponding to a contribution value of a hidden state of a decoder according to the contribution value of the hidden state of the decoder in the updated sequence composed of hidden states; and
obtaining a probability distribution of a word in the updated sequence composed of hidden states according to the updated sequence composed of hidden states and the context vector, and outputting the most probable word in the probability distribution of the word as a summary of the target text.

12. The computer device as claimed in claim 11, further comprising a step of putting a plurality of historical texts of a corpus into the first-layer LSTM structure and putting a text summary corresponding to the historical text into the second-layer LSTM structure for training to obtain the LSTM model, before obtaining the character included in the target text sequentially, and decoding the character according to the first-layer long short-term memory (LSTM) structure inputted into the LSTM model sequentially to obtain the sequence composed of hidden states.

13. The computer device as claimed in claim 11, wherein the LSTM model is a gated recurrent unit, and the gated recurrent unit has a model with the conditions of:
zₜ=σ(W_{z}·[hₜ₋₁, xₜ])
rₜ=σ(Wᵣ·[hₜ₋₁, xₜ])
\tilde{h}ₜ=tanh(W·[rₜ*hₜ₋₁, xₜ])
hₜ=(1−zₜ)*hₜ₋₁+zₜ*\tilde{h}ₜ
wherein, Wz, Wr, and W are trained weight parameter values, xₜ is an input, hₜ₋₁ is a hidden state, zₜ is an updated state, rₜ is a reset signal, \tilde{h}ₜ is a new memory corresponding to the hidden state hₜ₋₁, hₜ is an output, σ ( ) is a sigmoid function, and tanh ( ) is a hyperbolic tangent function.

14. The computer device as claimed in claim 13, wherein the sequence composed of hidden states is inputted into the second-layer LSTM structure of the LSTM model for decoding to obtain the word sequence of the summary, and the word sequence of the summary is a polynomial distribution layer having the same size as the vocabulary, and a vector y^{t}∈R^{K} is outputted; wherein the n^{th} dimension of y^{t} represents the probability of generating the k^{th} word, t is a value of a positive integer, and K is the size of the corresponding vocabulary of the historical text.

15. The computer device as claimed in claim 12, wherein the step of inputting the sequence composed of hidden states into the second-layer LSTM structure of the LSTM model for decoding to obtain the word sequence of the summary further comprises the steps of:
obtaining the most probable word in the sequence composed of hidden states, using the most probable word in the sequence composed of hidden states as an initial word in the word sequence of the summary;
inputting each word in the initial word into the second-layer LSTM structure, and combining each word in the initial word with each word in the vocabulary of the second-layer LSTM structure to obtained a combined sequence, and then obtaining and using the most probable word in the combined sequence as the sequence composed of hidden states;
repeating the steps of inputting each word in the sequence composed of hidden states into the second-layer LSTM structure, and combining each word in the sequence composed of hidden states with each word in the vocabulary of the second-layer LSTM structure to obtain the combined sequence, and then obtaining and using the most probable word in the combined sequence as the sequence composed of hidden states, until each word in the sequence composed of hidden states and an end character in the vocabulary are detected, and using the sequence composed of hidden states as the word sequence of the summary

16. A non-transitory computer-readable storage medium, for storing a computer program, and the computer program comprising a program instruction, wherein when the program instruction is executed by a processor, the processor executes the operations of:
obtaining a character included in a target text sequentially, decoding the character according to a first-layer long short-term memory (LSTM) structure inputted into a LSTM model sequentially to obtain a sequence composed of hidden states, wherein the LSTM model is a LSTM neural network;
inputting the sequence composed of hidden states into a second-layer LSTM structure of the LSTM model and decoding the sequence composed of hidden states to obtain a word sequence of a summary;
inputting the word sequence of the summary into the first-layer LSTM structure of the LSTM model and decoding the word sequence of the summary to obtain an updated sequence composed of hidden states;
obtaining a context vector corresponding to a contribution value of a hidden state of a decoder according to the contribution value of the hidden state of the decoder in the updated sequence composed of hidden states; and
obtaining a probability distribution of a word in the updated sequence composed of hidden states according to the updated sequence composed of hidden states and the context vector, and outputting the most probable word in the probability distribution of the word as a summary of the target text.

17. The non-transitory computer-readable storage medium as claimed in claim 16, further comprising a step of putting a plurality of historical texts of a corpus into the first-layer LSTM structure and putting a text summary corresponding to the historical text into the second-layer LSTM structure for training to obtain the LSTM model, before carrying out the steps of sequentially obtaining the character included in the target text and decoding the character according to the LSTM structure inputted into the LSTM model sequentially to obtain the sequence composed of hidden states.

18. The non-transitory computer-readable storage medium as claimed in claim 16, wherein the LSTM model is a gated recurrent unit, and the gated recurrent unit has a model with the conditions of:
zₜ=σ(W_{z}·[hₜ₋₁, xₜ])
rₜ=σ(Wᵣ·[hₜ₋₁, xₜ])
\tilde{h}ₜ=tanh(W·[rₜ*hₜ₋₁, xₜ])
hₜ=(1−zₜ)*hₜ₋₁+zₜ*\tilde{h}ₜ
wherein, Wz, Wr, and W are trained weight parameter values, xₜ is an input, hₜ₋₁ is a hidden state, zₜ is an updated state, rₜ is a reset signal, \tilde{h}ₜ is a new memory corresponding to the hidden state hₜ₋₁, hₜ is an output, σ ( ) is a sigmoid function, and tanh ( ) is a hyperbolic tangent function.

19. The non-transitory computer-readable storage medium as claimed in claim 18, wherein the sequence composed of hidden states is inputted into the second-layer LSTM structure of the LSTM model for decoding to obtain the word sequence of the summary, and the word sequence of the summary is a polynomial distribution layer having the same size as the vocabulary, and a vector y^{t}∈R^{K} is outputted; wherein the n^{th} dimension of y^{t} represents the probability of generating the k^{th} word, t is a value of a positive integer, and K is the size of the corresponding vocabulary of the historical text.

20. The non-transitory computer-readable storage medium as claimed in claim 17, wherein the step of inputting the sequence composed of hidden states into the second-layer LSTM structure of the LSTM model for decoding to obtain the word sequence of summary further comprises the steps of:
obtaining the most probable word in the sequence composed of hidden states, using the most probable word in the sequence composed of hidden states as an initial word in the word sequence of the summary;
inputting each word in the initial word into the second-layer LSTM structure, and combing each word in the initial word with each word in the vocabulary of the second-layer LSTM structure to obtained a combined sequence, and then obtaining and using the most probable word in the combined sequence as the sequence composed of hidden states; and
repeating the steps of inputting each word in the sequence composed of hidden states into the second-layer LSTM structure, and combining each word in the sequence composed of hidden states with each word in the vocabulary of the second-layer LSTM structure to obtain the combined sequence, and then obtaining and using the most probable word in the combined sequence as the sequence composed of hidden states, until each word in the sequence composed of hidden states and an end character in the vocabulary are detected, and using the sequence composed of hidden states as the word sequence of the summary
